(19) United States
(12) Patent Application Publication
(10) Pub. No.: US 2024/0191047 A1
(43) Pub. Date: Jun. 13, 2024

(54) POLYMER ION EXCHANGE MEMBRANE, SOLID ELECROL YTE ELECTROLYSIS DEVICE AND METHOD FOR ELECTROLYZING CARBON DIOXIDE WITH USE OF SAME

(71) Applicant: IDEMITSU KOSAN CO.,LTD., Chiyoda-ku (JP)

(72) Inventors: Hiroyuki KANEKO, Tokyo (JP); Qingxin JIA, Tokyo (JP)

(73) Assignee: IDEMITSU KOSAN CO.,LTD., Chiyoda-ku (JP)

(21) Appl. No.: 18/550,577

(22) PCT Filed: Mar. 8, 2022
(86) PCT No.: PCT/JP2022/010131

§ 371 Date: Sep. 14, 2023

(30) Foreign Application Priority Data
Mar. 19, 2021 (JP) 2021-046542

(51) Int. Cl. C25B 13/08; C25B 1/23

(52) U.S. Cl. CPC C25B 13/08; C25B 1/23

(57) ABSTRACT

A polymer ion exchange membrane including an ion exchange resin (A) having a basic site density DA and an ion exchange resin (B) having a basic site density DB, wherein a difference (DA—DB) between the basic site density DA and the basic site density DB is 0.3 mmol/cm³ or more.

### TECHNICAL FIELD

The present disclosure relates to a polymer ion exchange membrane, a solid-electrolyte electrolytic device, and a carbon dioxide electrolysis method using the solid-electrolyte electrolytic device.

### BACKGROUND ART

Studies on carbon dioxide reduction using electrical energy are widely conducted throughout the world. In a solid-electrolyte electrolytic device in which carbon dioxide is reduced, generally, carbon dioxide is dissolved in an aqueous solution containing an electrolyte to be supplied to a cathode, while an anode is supplied with the aqueous solution containing the electrolyte. Generally, the electrolyte for exchanging ions is provided between the cathode and the anode, and an ion exchange membrane may be used as a member of the electrolyte. An example of such a solid-electrolyte electrolytic device is the carbon dioxide electrolytic device disclosed in Patent Literature 1.

### CITATION LIST

### Patent Literature

Patent Literature 1: JP 2018-154901 A

### SUMMARY OF INVENTION

### Technical Problem

An ion exchange membrane used as a separator for the carbon dioxide electrolytic device disclosed in Patent Literature 1 is disposed between an anode and a cathode. Due to its structure, the ion exchange membrane has a property of permeating not only ions but also electrolytes. A phenomenon (hereinafter may be referred to as crossover) in which a small amount of the electrolyte supplied to the anode permeates through the ion exchange membrane and precipitates as a salt in the vicinity of the cathode is often found. The precipitated salt has adverse effects such as hindering the supply of carbon dioxide to the cathode catalyst, and may cause a decrease in the electrolytic performance such as current density and selectivity.

The cause of the crossover phenomenon is, for example, swelling caused by the fact that the ion exchange membrane absorbs water or alcohol in a molecular state, or water obtained by bonding ion exchange functional groups of the ion exchange membrane, which is a polymer membrane, with H⁺ or OH⁻. That is, as the ion exchange membrane swells, gaps occur between the polymer linear chains, and hydrated electrolyte ions can permeate through the membrane. Therefore, in particular, as the ion conductivity is higher and the ion exchange capacity of the membrane is larger, the swelling property is higher and the crossover phenomenon is more likely to occur.

### Solution to Problem

In order to prevent such a crossover phenomenon, a pore-filling membrane has been developed. The pore-filling membrane has a structure in which pores of a porous resin membrane having no ion-exchangeability are filled with an ion exchange polymer. Such a porous resin does not swell, and thus, the ion exchange polymer is fixed in its pores, suppressing the swelling of the membrane. However, there is a disadvantage in that the ion conductivity of the membrane is greatly reduced, which may cause a decrease in the electrolytic performance of the solid-electrolyte electrolytic device. Therefore, an object of the technology according to the present disclosure is to solve the problem of providing a technology related to a polymer ion exchange membrane capable of suppressing the crossover phenomenon without using a pore-filling membrane and a solid-electrolyte electrolytic device using the polymer ion exchange membrane.

As a result of intensive studies to achieve the object, the present inventors have found that an ion exchange membrane using a combination of two types of ion exchange resins having different basic site densities can suppress the swelling due to water absorption, and have completed the technology according to the present disclosure. That is, the technology according to the present disclosure is as follows.

According to one aspect of the technology according to the present disclosure, it is possible to provide a polymer ion exchange membrane including an ion exchange resin (A) and an ion exchange resin (B), wherein a difference (DA—DB) between a basic site density DA of the ion exchange resin (A) and a basic site density DB of the ion exchange resin (B) is 0.3 mmol/cm³ or more.

### Advantageous Effects of Invention

According to the present disclosure, it is possible to provide a technology related to a polymer ion exchange membrane capable of suppressing the crossover phenomenon without using a pore-filling membrane and a solid-electrolyte electrolytic device using the polymer ion exchange membrane.

### BRIEF DESCRIPTION OF DRAWINGS

FIG. 1 is a schematic diagram showing an example of a solid-electrolyte electrolytic device according to the present disclosure.

FIG. 2 is a conceptual diagram showing a state in which CO₂ can be locally and efficiently adsorbed by adding a solid base to a cathode surface in a solid-electrolyte electrolytic device suitably used in an embodiment according to the present disclosure.

FIG. 3 is a schematic diagram showing a cross-sectional structure in the Z-Y axis direction of the polymer ion exchange membrane according to the present disclosure, wherein (a) is a diagram showing an example of a solid electrolyte in which an ion exchange resin (A) and an ion exchange resin (B) are laminated in the Y axis direction. (b) is a diagram showing an example of a solid electrolyte in which a portion of the ion exchange resin (B) is provided between portions of the ion exchange resin (A). (c) is a diagram showing an example of a solid electrolyte in which a portion of the ion exchange resin (A) is provided between portions of the ion exchange resin (B). (d) is a diagram showing an example of a solid electrolyte in which the ion exchange resin (A) and the ion exchange resin (B) are laminated in a checkered pattern in the Y axis direction. (e) is a diagram showing an example of a solid electrolyte in which the ion exchange resin (A) and the ion exchange resin (B) are alternately laminated in the Z axis direction. (f) is a diagram showing an example of a solid electrolyte in which the ion exchange resin (A) is filled in the ion exchange resin (B).

FIG. 4 is a flowchart showing a synthesis gas production method using the solid-electrolyte electrolytic device suitably used in the embodiment according to the present disclosure.

FIG. 5 is an application example of the solid-electrolyte electrolytic device suitably used in the embodiment according to the present disclosure.

FIG. 6 is a photograph (a) of a back surface of an unused cathode and a photograph (b) of an unused CO₂ flow channel, which are used for an evaluation according to the present disclosure.

FIG. 7 is a photograph (a) of a back surface of a cathode of Example 1 and a photograph (b) of a CO₂ flow channel of Example 1, which are evaluation results according to the present disclosure.

FIG. 8 is a photograph (a) of a back surface of a cathode of Comparative Example 2 and a photograph (b) of a CO₂ flow channel of Comparative Example 2, which are evaluation results according to the present disclosure.

### DESCRIPTION OF EMBODIMENTS

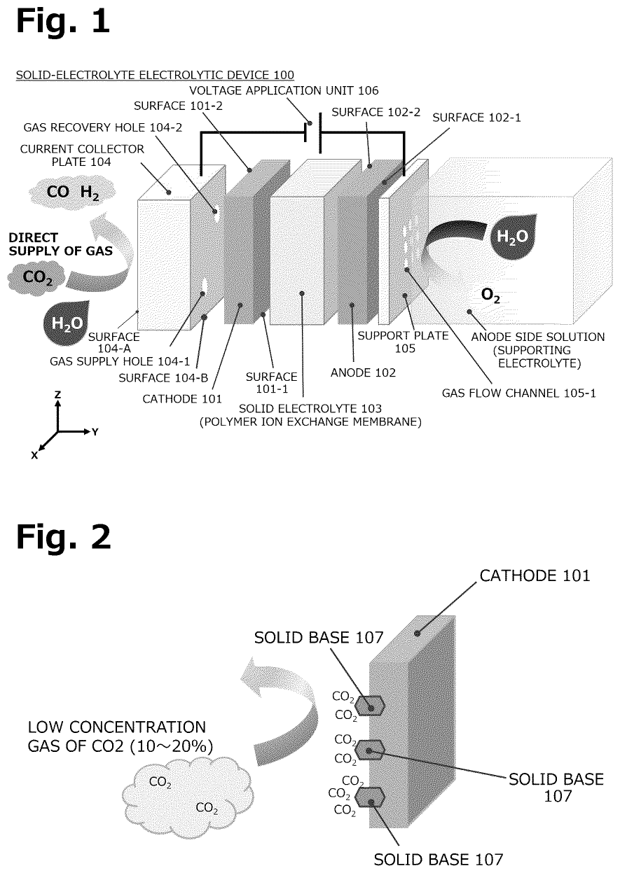

Hereinafter, the polymer ion exchange membrane and the solid-electrolyte electrolytic device according to the present disclosure will be specifically described with reference to FIGS. 1 to 3. Note that the invention according to the present disclosure is not limited to the embodiment described below. In addition, in the present disclosure, the term “to” relating to the description of a numerical value is a term indicating a lower limit value or more and an upper limit value or less.

### <<Solid-Electrolyte Electrolytic Device 100>>

First, a solid-electrolyte electrolytic device (also referred to as an electrolytic cell or an electrolytic module) according to the present embodiment will be described with reference to FIG. 1. As shown in FIG. 1, a solid-electrolyte electrolytic device 100 according to the present embodiment includes a cathode 101, an anode 102 forming a pair of electrodes with the cathode 101, a solid electrolyte 103 disposed between the cathode 101 and the anode 102 with at least a portion of the solid electrolyte 103 in contact with them, a current collector plate 104 in contact with a surface 101-2 of the cathode 101 opposite to a contact surface 101-1 with the solid electrolyte 103, a support plate 105 in contact with a surface 102-1 of the anode 102 opposite to a contact surface 102-2 with the solid electrolyte 103, and a voltage application unit 106 for applying a voltage between the current collector plate 104 and the support plate 105 (i.e., between the cathode 101 and the anode 102). CO₂ in a gaseous state is supplied by a supply source and a supply device which are not shown. Although the solid-electrolyte electrolytic device 100 shown in FIG. 1 is shown in a state in which components such as the cathode 101 and the anode 102 are separated from each other for the sake of description, the current collector plate 104, the cathode 101, the solid electrolyte 103, the anode 102, and the support plate 105 are actually respectively bonded by a predetermined method to be integrated. Each component may be configured to be detachable to constitute one solid-electrolyte electrolytic device 100. The polymer ion exchange membrane according to the present disclosure is used as the solid electrolyte 103. Hereinafter, each component will be described in detail.

### <Cathode 101>

### (Reduction Reaction at Cathode 101)

The reduction reaction at the cathode 101 varies depending on the type of the solid electrolyte 103 used in the solid-electrolyte electrolytic device 100. When a cation exchange membrane is used as the solid electrolyte 103, reduction reactions represented by the following formulas (1) and (2) occur, and when an anion exchange membrane is used as the solid electrolyte, reduction reactions represented by the following formulas (3) and (4) occur.

[Formula 1]

CO₂+2H⁺+2e⁻→CO+H₂O (1)

2H⁺+2e⁻→H₂ (2)

H₂O+CO₂+2e⁻→CO+2OH⁻ (3)

2H₂O+2e⁻→H₂+2OH (4)

### (Basic Structure and Material of Cathode 101)

The cathode 101 is a gas diffusion electrode including a gas diffusion layer. The gas diffusion layer includes, for example, a conductive or porous material such as carbon paper or nonwoven fabric, or a metal mesh. Examples of the electrode material of the cathode 101 may include graphite carbon, glassy carbon, titanium, and SUS. The cathode catalyst of the cathode 101, which is capable of reducing CO₂ (carbon dioxide) to CO (carbon monoxide), includes, for example, a metal selected from silver, gold, copper, or a combination thereof. More specifically, the catalyst includes, for example, gold, a gold alloy, silver, a silver alloy, copper, a copper alloy, or a mixed metal including any one or more thereof. The type of the catalyst is not particularly limited as long as it has a function as a catalyst, and can be determined in consideration of corrosion resistance and the like. For example, when the catalyst does not contain an amphoteric metal such as Al, Sn, or Zn, the corrosion resistance can be improved. The catalyst can be supported on the cathode 101 (or the electrode material) by performing a known method such as vapor deposition, precipitation, adsorption, deposition, adhesion, welding, physical mixing, or spraying.

### (Solid Base 107)

Here, as shown in FIG. 2, the cathode 101 includes a solid base 107. The solid base 107 is not particularly limited as long as it is a solid at room temperature (25° C.), and for example, as inorganic compounds, it is preferable to use potassium hydrogen carbonate (KHCO₃), sodium hydroxide (NaOH), alkaline earth metal oxides, alkaline earth metal hydroxides or alkaline earth metal carbonates {e.g. magnesium oxide (MgO), magnesium hydroxide (Mg(OH)₂), magnesium carbonate (MgCO₃), calcium oxide (CaO), calcium hydroxide (Ca(OH)₂), calcium carbonate (CaCO₃), strontium oxide (SrO), strontium hydroxide (Sr(OH)₂), strontium carbonate (SrCO₃), barium oxide (BaO), barium hydroxide (Ba(OH)₂), barium carbonate (BaCO₃), etc.}, oxides of rare earth metals, hydroxides of rare earth metals or rare earth metals carbonate {e.g. yttrium oxide (Y₂O₃), lanthanum oxide (La₂O₃), etc.}, hydrotalcite (e.g., metal complex hydroxide, carbonate, LDH, HT-CO₃, HT-OH, etc.), surface base-treated Zeolite, base-treated molecular sieve, surface base-treated porous alumina (KF-Al₂O₃), ammonium salt, etc. As the organic compound, it is preferable to use amines, polymers having a functional group such as a quaternary ammonium group, a primary amino group, a secondary amino group, or a tertiary amino group, etc., or the like. In particular, a weakly basic solid base with a small atomic number is more preferable. It is more preferable to use a water-insoluble solid base such as an oxide of an alkaline earth metal, a hydroxide or a carbonate of an alkaline earth metal, an oxide of a rare earth metal, a hydroxide or a carbonate of a rare earth metal because the solid base is not washed away by water in the gas or water produced by the reaction and the durability of the cathode having the solid base 107 is not reduced. Here, “water-insoluble” indicates a case that a 10 mg mass does not dissolve in 100 ml of water at 20° C. It is preferable that the solid base 107 is present on the side of the contact surface 101-1 of the cathode 101 with the solid electrolyte 103. The reason for this configuration is that the interface between the cathode 101 and the solid electrolyte 103 is a reaction site. In addition, the solid base 107 may be present as a mixture with the material of the cathode 101 or may be present in an integrated state as a compound. The solid base 107 can be supported on the cathode 101 (or the electrode material) by performing a known method such as coating, vapor deposition, precipitation, or physical mixing. The mass per unit area of the solid base is not particularly limited, and is, for example, 0.1 to 10 mg/cm², preferably 0.1 to 6 mg/cm².

Here, the reason why the use of the solid base 107 increases the efficiency is presumed to be due to the following action mechanism. First, for example, when a low-concentration CO₂ gas with a concentration of 10% to 20%, such as an exhaust gas from a factory, is supplied to the solid-electrolyte electrolytic device 100, the CO₂ is unlikely to be adsorbed on the surface of the cathode 101 because of the low concentration of CO₂. Therefore, as shown in FIG. 1, it is understood that by adding the solid base 107 to the surface of the cathode 101, CO₂ can be locally and efficiently adsorbed to a portion where the solid base is present, and CO₂ reduction can be proceeded. In addition, it is understood that when a cation exchange membrane is used as the solid electrolyte 103, CO₂ cannot be sufficiently adsorbed when there are many H⁺ on the surface of the cathode 101. At this time, it is considered that the reaction proceeds once the solid base 107 is present. On the other hand, when an anion exchange membrane is used as the solid electrolyte, CO₂ is adsorbed because OH is present on the surface of the cathode, and thus, the anion exchange membrane is suitable for CO₂ reduction. However, it is understood that when the amount of OH is too large, CO₂ is adsorbed as a stable CO₃²⁻ and the CO₂ reduction reaction does not proceed sufficiently. At this time, it is considered that when the weakly basic solid base 107 is present, the CO₂ reduction reaction further proceeds. According to the present disclosure, such an electrode including a solid base and a catalyst can be expressed as “an electrode including a catalyst, an electrode material containing a catalyst, and a solid base provided at least on the electrode material” (in other words, an electrode including an electrode material containing a catalyst and a solid base), “a cathode including a catalyst and further including a solid base”, or the like.

### <Anode 102>

### (Oxidation Reaction at Anode 102)

The oxidation reaction at the anode 102 varies depending on the type of the solid electrolyte 103 used in the solid-electrolyte electrolytic device 100. When a cation exchange membrane is used as the solid electrolyte 103, an oxidation reaction represented by the following formula (5) occurs, and when an anion exchange membrane is used as the solid electrolyte 103, an oxidation reaction represented by the following formula (6) occurs.

[Formula 2]

2H₂O→O₂+4 H⁺+4e⁻ (5)

4OH⁻→O₂+2H₂O+4e⁻ (6)

### (Basic Structure and Material of Anode 102)

The anode 102 is a gas diffusion electrode including a gas diffusion layer. The gas diffusion layer includes, for example, a metal mesh. Examples of the electrode material of the anode 102 include Ir, IrOₓ, Ru, RuO₂, Rh, RhOₓ, Co, CoOₓ, Cu, CuOₓ, Fe, FeOₓ, FeOOH, FeMn, Ni, NiOₓ, NiOOH, NiCo, NiCe, NiC, NiFe, NiCeCoCe, NiLa, NiMoFe, NiSn, NiZn, SUS, Au, and Pt.

### <Solid Electrolyte 103>

The solid electrolyte 103 is interposed at least partially in contact with the cathode 101 and the anode 102 between the cathode 101 and the anode 102. Here, the solid electrolyte 103 is the polymer ion exchange membrane according to the present disclosure.

The polymer ion exchange membrane according to the present disclosure includes the ion exchange resin (A) and the ion exchange resin (B), wherein a difference (DA—DB) between a basic site density DA of the ion exchange resin (A) and a basic site density DB of the ion exchange resin (B) is 0.3 mmol/cm³ or more.

The ion exchange resin (A) and the ion exchange resin (B) are not particularly limited as long as the difference (DA—DB) between the basic site density DA of the ion exchange resin (A) and the basic site density DB of the ion exchange resin (B) is 0.3 mmol/cm³ or more, and identical resins with different basic site densities or different resins can be used. The basic site densities of the ion exchange resin (A) and the ion exchange resin (B) indicate the level of ion exchangeability (ion exchange efficiency) of each resin, and an ion exchange resin with a high basic site density has a high ion exchangeability. Therefore, the ion exchange resin (A) is a resin having a higher ion exchangeability than the ion exchange resin (B). Therefore, the ion exchange resin (A) is more likely to swell and the ion exchange resin (B) is less likely to swell.

The basic site density DA of the ion exchange resin (A) is not particularly limited as long as the effect of the technology according to the present disclosure is not impaired, and for example, the basic site density DA can be 0.6 mmol/cm³ or more and 4.0 mmol/cm³ or less, and preferably 1.0 mmol/cm³ or more and 3.0 mmol/cm³ or less. When the basic site density DA of the ion exchange resin (A) is in such a range, an effect of securing sufficient ion conductivity can be obtained.

The basic site density DB of the ion exchange resin (B) is not particularly limited as long as the effect of the technology according to the present disclosure is not impaired, and for example, the basic site density DB can be 0.3 mmol/cm³ or more and 3.0 mmol/cm³ or less, and preferably 0.5 mmol/cm³ or more and 1.8 mmol/cm³ or less. When the basic site density DB of the ion exchange resin (B) is in such a range, the effect of suppressing the progress of crossover can be obtained.

The ion exchange resin (A) and the ion exchange resin (B) are not particularly limited as long as they do not impair the effect of the technology according to the present disclosure, and examples thereof include anion exchange membranes having quaternary ammonium groups, primary amino groups, secondary amino groups, and tertiary amino groups, and anion exchange membranes in which a plurality of these ion exchange groups are mixed, and ionomers are suitable because they can provide a high basic site density:

The base resin of the ionomer is not particularly limited as long as the effect of the technology according to the present disclosure is not impaired, and for example, the base resin may be a copolymer obtained by copolymerizing an ethylene-based monomer, a styrene-based monomer, a urethane-based monomer, a halogen-based monomer, and a polymer obtained by polymerizing these monomers in advance. As these copolymers, any of a random copolymer, a block copolymer, a graft copolymer, an alternating copolymer and the like can be used. One of these copolymers can be used alone, and a combination of a plurality of these copolymers can be used.

The basic site density DA of the ion exchange resin (A) and the basic site density DB of the ion exchange resin (B) can be adjusted according to the ratio of the hydrophobic structure to the hydrophilic structure in the molecular structure of each resin. Therefore, the basic site density of the anion exchange resin can be adjusted by copolymerizing a monomer having a hydrophobic structure or a polymer obtained by polymerizing the monomer in advance with a monomer having a hydrophilic structure or a polymer obtained by polymerizing the monomer in advance while adjusting the blending ratio of each of the monomers.

Examples of the ionomer include those having an amino group or a quaternary ammonium group, and since these groups are hydrophilic groups, it is preferable to add them to a monomer or a polymer in advance for use in order to adjust the basic site concentration. As the hydrophobic monomer or hydrophobic polymer to be added for adjusting the basic site density, a halide monomer, an aromatic monomer or a polymer thereof can be used because of their high hydrophobicity, and it is particularly preferable to use a fluorine monomer.

The basic site densities of the ion exchange resin (A) and the ion exchange resin (B) are obtained by 1H-NMR measurement, for example, based on integrated values of signals of amino groups, quaternary ammonium groups, and other functional groups serving as basic sites.

The polymer ion exchange membrane according to the present disclosure includes the ion exchange resin (A) and the ion exchange resin (B), and may have either a structure in which the ion exchange resin (A) and the ion exchange resin (B) separately form one or a plurality of regions which are combined together (hereinafter may be referred to as a hybrid membrane) or a structure formed, for example, by melt-mixing the ion exchange resin (A) and the ion exchange resin (B) at an arbitrary blending ratio (hereinafter may be referred to as a composite membrane). With such a structure, the ion exchange resin (A), which has a high ion exchangeability and is easy to swell, maintains the ion exchangeability of the polymer ion exchange membrane, and the ion exchange resin (B) which has a relatively low ion exchangeability and is hard to swell prevents the whole polymer ion exchange membrane from swelling. Thereby, the crossover phenomenon can be suppressed, and the solid-electrolyte electrolytic device using the polymer ion exchange membrane can continuously maintain the excellent electrolytic performance. Therefore, the difference (DA—DB) between the basic site density DA of the ion exchange resin (A) and the basic site density DB of the ion exchange resin (B) is 0.3 mmol/cm³ or more, preferably 0.5 mmol/cm³ or more.

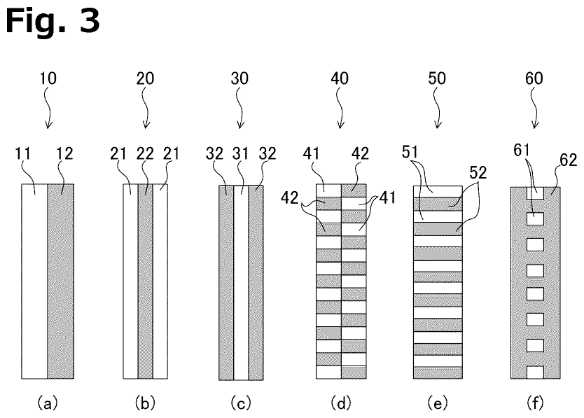

The cross-sectional views in the Z-Y axis direction of a structural example of the hybrid membrane of the ion exchange resin (A) and the ion exchange resin (B) are shown in FIGS. 3(a) to 3(f). FIG. 3(a) shows a polymer ion exchange membrane having a structure in which the ion exchange resin (A) and the ion exchange resin (B) are laminated in the Y axis direction. Here, the laminated structure may be a structure in which a plurality of membranes are laminated or a membrane in which a plurality of ion exchange resin layers are integrally laminated. FIG. 3(b) shows a polymer ion exchange membrane having a structure in which a portion of the ion exchange resin (B) is sandwiched between two portions of the ion exchange resin (A) and the portions are laminated in the Y axis direction, and FIG. 3(c) shows a structure in which the ion exchange resin (A) and the ion exchange resin (B) in FIG. 3(b) are replaced with each other. Although FIGS. 3(a) to 3(c) show a case where the number of layers is 2 and a case where the number of layers is 3, it is also possible to use a structure in which 4 or more layers of the ion exchange resin (A) and the ion exchange resin (B) are alternately laminated in the surface direction of the membrane. FIG. 3(e) shows a structure in which the ion exchange resin (A) and the ion exchange resin (B) are alternately laminated in the Z axis direction. This structure may be a structure obtained by filling a porous membrane of the ion exchange resin (A) with the ion exchange resin (B) or a structure obtained by filling a porous membrane of the ion exchange resin (B) with the ion exchange resin (A). FIG. 3(d) shows a structure in which two polymer ion exchange membranes shown in FIG. 3(e) are laminated in the Y axis direction in a manner that the ion exchange resin (A) and the ion exchange resin (B) of respective membranes are alternately in contact with each other, i.e., arranged in a checkered pattern (checkerboard pattern). Alternatively, it may be a structure of laminating a membrane obtained by filling a porous membrane of the ion exchange resin (A) with the ion exchange resin (B) and a membrane obtained by filling a porous membrane made of the ion exchange resin (B) with the ion exchange resin (A). FIG. 3(f) shows a structure in which the ion exchange resin (A) is filled in the form of being enclosed in the ion exchange resin (B). When either the portion of the ion exchange resin (A) or the portion of the ion exchange resin (B) contained in these polymer ion exchange membranes is a dense resin, the resin of the other portion may have a pore structure such as a mesh structure or a porous structure. The arrangement of the ion exchange resin (A) and the ion exchange resin (B) is not particularly limited, and the ion exchange resin (A) may be arranged on the cathode side and the ion exchange resin (B) may be arranged on the anode side to form a polymer ion exchange membrane, or the ion exchange resin (B) may be arranged on the cathode side and the ion exchange resin (A) may be arranged on the anode side to form a polymer ion exchange membrane. The above-described production can be performed using a known method. The mass ratio (A:B) of the ion exchange resin (A) to the ion exchange resin (B) in the polymer ion exchange membrane is preferably 1:10 to 10:1, more preferably 1:5 to 5:1, particularly preferably 1:3 to 3:1. When the polymer ion exchange membrane has a laminated structure in which the layers of the ion exchange resin (A) and the layers of the ion exchange resin (B) are laminated, the ratio (A:B) of the total thickness of the layers of the ion exchange resin (A) to the total thickness of the layers of the ion exchange resin (B) is preferably 1:10 to 10:1, more preferably 1:5 to 5:1, particularly preferably 1:3 to 3:1. The polymer ion exchange membrane may contain other components as long as the effect of the present invention is not impaired. The total mass of the ion exchange resin (A) and the ion exchange resin (B) in the polymer ion exchange membrane can be, for example, 50% by mass or more, 70% by mass or more, 90% by mass or more, 95% by mass or more, 99% by mass or more, or 100% by mass, etc.

### <Current Collector Plate 104>

Examples of the material of the current collector plate 104 include metal materials such as copper (Cu), nickel (Ni), stainless steel (SUS), nickel-plated steel, and brass, and among these, copper is preferable in terms of ease of processing and cost. When the current collector plate 104 is made of a metal material, examples of the shape of the negative electrode current collector plate include a metal foil, a metal plate, a metal thin film, an expanded metal, a punching metal, and a foamed metal.

Here, as shown in FIG. 1, the current collector plate 104 is provided with a gas supply hole 104-1 and a gas recovery hole 104-2 for supplying and recovering a gas (raw material gas or produced gas) to and from the cathode 101. Using the gas supply hole 104-1 and the gas recovery hole 104-2, it is possible to uniformly and efficiently feed a raw material gas to the cathode 101 and discharge a produced gas (including the unreacted raw material gas) from the cathode 101. Although one gas supply hole and one gas recovery hole are respectively provided in the drawing, the number, location, and size of the holes are not limited and may be set as appropriate. In addition, when the current collector plate 104 has breathability, the gas supply hole and the gas recovery hole are not necessarily required.

When the cathode 101 has a role of transmitting electrons, the current collector plate 104 is not necessarily required.

### <Support Plate 105>

The support plate 105 serves to support the anode 102. Therefore, the required rigidity of the support plate 105 also varies depending on the thickness, rigidity, etc. of the anode 102. The support plate 105 needs to have electrical conductivity in order to receive electrons from the anode 102. Examples of the material of the support plate 105 may include Ti, SUS, and Ni.

Here, as shown in FIG. 1, the support plate 105 is provided with a gas flow channel 105-1 for feeding a raw material gas (H₂O or the like) to the anode 102. The gas flow channel makes it possible to feed the raw material gas to the anode 102 uniformly and efficiently. Although 9 gas flow channels are provided in the drawing, the number, location, and size of the channels are not limited and may be set as appropriate.

In this embodiment, the anode 102 and the support plate 105 are described as separate objects, but the anode 102 and the support plate 105 may have an integrated structure (that is, may be configured as an integrated anode 102 having a supporting function).

### <Voltage Application Unit 106>

The voltage application unit 106 serves to apply a voltage between the cathode 101 and the anode 102 by applying a voltage to the current collector plate 104 and the support plate 105 as shown in FIG. 1. Here, as described above, the current collector plate 104 is a conductor, and thus, it supplies electrons to the cathode 101, and on the other hand, the support plate 105 is also a conductor, and thus, it receives electrons from the anode 102. When the current collector plate 104 is not required as described above, a voltage is applied between the cathode 101 and the support plate 105. A control unit which is not shown may be electrically connected to the voltage application unit 106 in order to apply an appropriate voltage.

### <Reaction Gas Supply Unit>

In the solid-electrolyte electrolytic device 100 according to the present disclosure, a reaction gas supply unit which is not shown may be provided outside the solid-electrolyte electrolytic device 100. That is, as long as CO₂ as the reaction gas can be supplied to the surface 101-2, the reaction gas may be supplied from the reaction gas supply unit to the gas supply hole 104-1 through a pipe which is not shown or the like, or the reaction gas supply unit may be provided in a manner that the reaction gas can be blown onto a surface 104-A of the current collector plate 104 opposite to the contact surface 104-B with the cathode 101. In addition, it is preferable to use a factory exhaust gas discharged from a factory as the reaction gas from an environmental point of view.

### Others

The solid-electrolyte electrolytic device 100 according to the present disclosure may include other components such as electrical components, control components, piping components such as valves, pipes, and tanks which are necessary for the solid-electrolyte electrolytic device.

### <<CO Production Method>>

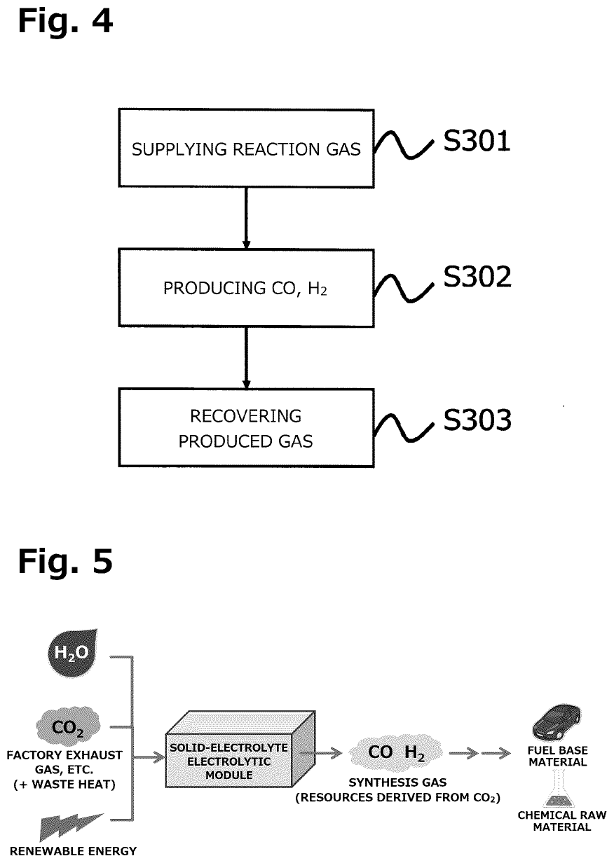

Next, a carbon dioxide electrolysis method (CO production method) using the above-described solid-electrolyte electrolytic device 100 will be described with reference to FIG. 4.

### <Reaction Gas Supply Step S301>

First, CO₂ contained in a reaction gas as a raw material is supplied to the solid-electrolyte electrolytic device 100 in a gaseous state by the reaction gas supply unit which is not shown. At this time, CO₂ is supplied to the cathode 101 through the gas supply hole 104-1 provided in the current collector plate 104 (S301).

### <CO and H₂ Production Step S302>

Next, the CO₂ supplied to the cathode 101 produces a synthesis gas containing at least CO and H₂ (S302) on the surface of the cathode 101 by the reduction reactions of the above-described formulas (1) and (2) in which a cation exchange membrane is used as the solid electrolyte 103, or by the reduction reactions of the above-described formulas (3) and (4) in which an anion exchange membrane is used as the solid electrolyte.

### <Produced Gas Recovery Step S303>

Next, the produced synthesis gas containing CO and H₂ is sent to a gas recovery device which is not shown through the gas recovery hole 104-2 provided in the current collector plate 104, and is recovered to each type of predetermined gases (S303).

### Application

As shown in FIG. 5, it is possible to produce a synthesis gas containing at least CO and H₂ at a desired production ratio by, for example, using CO₂ gas discharged from a factory as a raw material and utilizing renewable energies of solar cells or the like for the voltage application unit 106 in the solid-electrolyte electrolytic device according to the present disclosure as described above. The synthesis gas thus produced can be used to produce a fuel base material or a chemical raw material by a technique such as the Fischer-Tropsch process or methanation. In addition, although the solid-electrolyte electrolytic device has been described as an example in the present embodiment, the ion exchange membrane according to the present disclosure is not limited thereto, and can be applied to any device in which a salt may be precipitated due to a balance between ion conductivity and permeation selectivity, such as a fuel cell, a metal-air battery, electrodialysis, and a desalination treatment device.

Next, the technology according to the present disclosure will be described in detail with reference to Examples and Comparative Examples, but the technology according to the present disclosure is not limited thereto.

The solid-electrolyte electrolytic device is assembled from the following components. A mixture of carbon black having conductivity and a silver nano-catalyst is attached to carbon paper and used as a cathode. A titanium mesh supporting iridium oxide is used as an anode. As the solid electrolyte, the polymer ion exchange membrane of Example 1 has the structure shown in FIG. 3(a), in which one layer of each of the following membranes is laminated: a fluororesin-based ionomer anion exchange membrane (30 μm thick) with a basic site density of 2.9 mmol/cm³, aromatics in the main chain, and quaternary ammonium groups in the side chains, as the ion exchange resin (A): and a fluororesin-based ionomer anion exchange membrane (30 μm thick) with a basic site density of 1.4 mmol/cm³, aromatics in the main chain, and quaternary ammonium groups in the side chains, as the ion exchange resin (B). Further, a layer of the ion exchange resin (A) is arranged on the anode side.

Each of the polymer ion exchange membranes of Comparative Examples 1 to 3 has a structure of laminating two layers of a fluororesin-based ionomer anion exchange membrane (30 μm thick) with the basic site density being respectively 2.9 mmol/cm³, 2.1 mmol/cm³, and 1.4 mmol/cm³, aromatics in the main chain, and quaternary ammonium groups in the side chains. The polymer ion exchange membrane of Comparative Example 4 has the structure shown in FIG. 3(a), in which one layer of each of the following membranes is laminated: a fluororesin-based ionomer anion exchange membrane (30 μm thick) with a basic site density of 2.9 mmol/cm³, aromatics in the main chain, and quaternary ammonium groups in the side chains, as the ion exchange resin (A): and a fluororesin-based ionomer anion exchange membrane (40 μm thick) with a basic site density of 2.7 mmol/cm³, aromatics in the main chain, and quaternary ammonium groups in the side chains, as the ion exchange resin (B). Further, a layer of the ion exchange resin (A) is arranged on the anode side. A 0.5M KHCO₃ aqueous solution is used as the electrolyte.

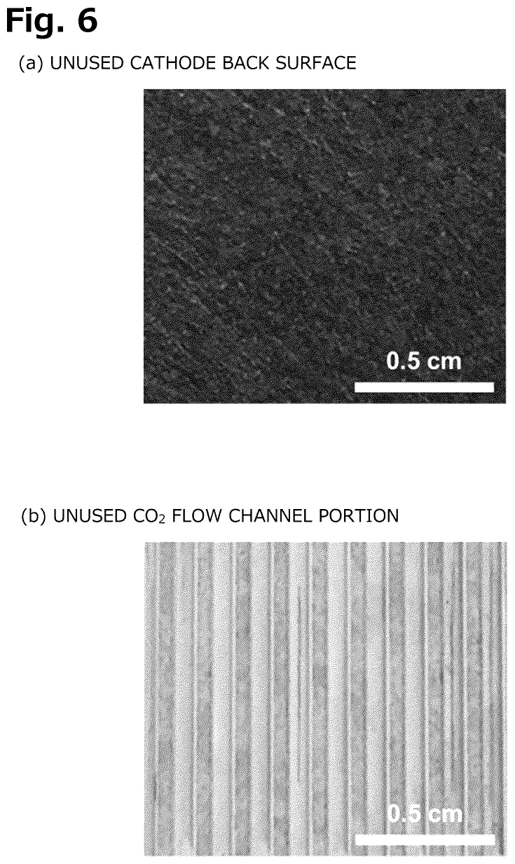

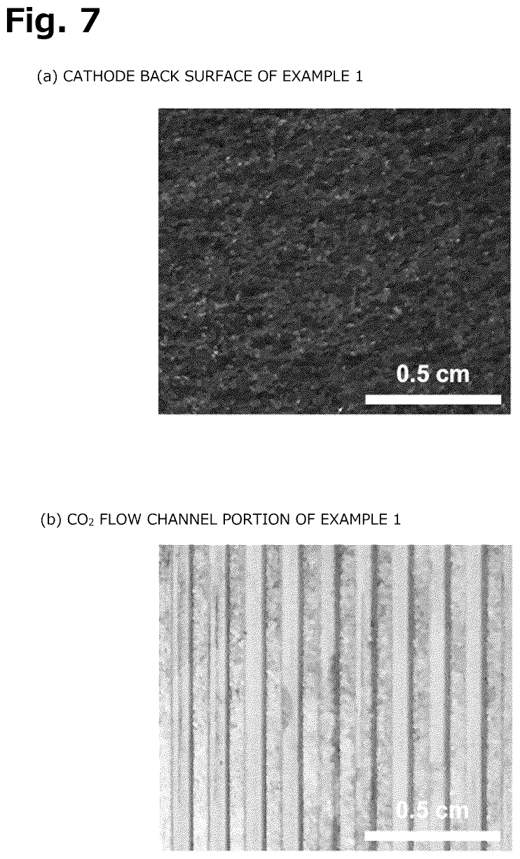

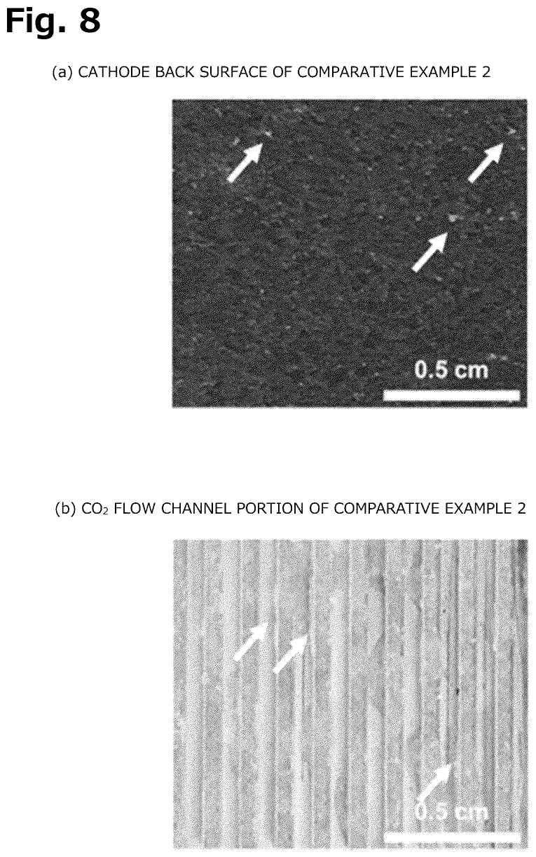

The solid-electrolyte electrolytic device is operated to continue the CO₂ reduction reaction for 20 hours, and the CO production current density (J_{CO}), the H₂ production current density (J_{H2}), and the CO selectivity (S_{CO}) are measured. At this time, the applied potential of the cathode is −1.8 V with respect to a silver/silver chloride reference electrode. The results are shown in Table 1. After 20 hours of continuous electrolysis, a decrease in J_{CO} and a decrease in S_{CO} are confirmed in Comparative Examples 1 to 4, while in Example 1, there is no decrease in J_{CO} and the amount of decrease in S_{CO} is less than in Comparative Examples 1 to 4, confirming the effect of the technology according to the present disclosure. Thereafter, the devices of Example 1 and Comparative Examples 1 to 4 are disassembled, and the precipitated salts adhering to the cathode and the CO₂ flow channel portion are observed with the naked eye. As a result, the deposited salts are not observed in the cathode and the CO₂ flow channel portion used in the evaluation of Example 1, and the deposited salts are remarkably observed in the cathode and the CO₂ flow channel portion used in the evaluation of Comparative Examples 1 to 4, confirming the effect of the technology according to the present disclosure. FIGS. 6 to 8 show photographs of the unused cathode and CO₂ flow channel portion of Example 1 and Comparative Example 2. In addition, in FIG. 8, adhesion positions of the deposited salts are indicated by arrows.

TABLE 1

| | | | | | After 20 Hours of | | | | |
|---|---|---|---|---|---|---|---|---|---|
| | | Initial Stage of | | | Continuous | | | J_{CO} | S_{CO} |
| | Type of Membrane | Electrolysis | | | Electrolysis | | | 50 mA/cm² | 80% |
| | Basic Site Density [mmol/cm³] | J_{co} | J_{H2} | S_{CO} | J_{co} | J_{H2} | S_{CO} | Reached | Reached |
| Example | 2.9 (Ion Exchange Resin (A)) | 58 | 4 | 93% | 60 | 8 | 88% | ✓ | ✓ |
| | 1.4 (lon Exchange Resin (B)) | | | | | | | | |
| Comparative | 2.9 Only | 75 | 6 | 92% | 50 | 39 | 56% | ✓ | — |
| Example 1 | | | | | | | | | |
| Comparative | 2.1 Only | 60 | 7 | 90% | 49 | 17 | 74% | — | — |
| Example 2 | | | | | | | | | |
| Comparative | 1.4 Only | 50 | 7 | 87% | 38 | 14 | 73% | — | — |
| Example 3 | | | | | | | | | |
| Comparative | 2.9 (Ion Exchange Resin (A)) | 44 | 3 | 94% | 18 | 7 | 72% | — | — |
| Example 4 | 2.7 (Ion Exchange Resin (B)) | | | | | | | | |

The solid-electrolyte electrolytic device is assembled from the following components. A mixture of carbon black having conductivity and a silver nano-catalyst is attached to carbon paper and used as a cathode. A titanium mesh supporting iridium oxide is used as an anode. The polymer ion exchange membranes of Examples 2 and 3 are: a fluororesin-based ionomer anion exchange membrane (50 μm thick) with a basic site density of 3.3 mmol/cm³, aromatics in the main chain, and quaternary ammonium groups in the side chains, as the ion exchange resin (A): and a fluororesin-based ionomer anion exchange membrane (40 μm thick) with a basic site density of 2.7 mmol/cm³, aromatics in the main chain, and quaternary ammonium groups in the side chains, as the ion exchange resin (B). In Example 2, as shown in FIG. 3(b) or FIG. 3(c), a laminated structure is configured in which a layer of the ion exchange resin (A) is sandwiched between a pair of layers of the ion exchange resin (B). In Example 3, a laminated structure is configured in which a layer of the ion exchange resin (B) is sandwiched between a pair of layers of the ion exchange resin (A).

Each of the polymer ion exchange membranes of Comparative Examples 5 and 6 has a structure of laminating a fluororesin-based ionomer anion exchange membrane with the basic site density being respectively 3.3 mmol/cm³ and 2.7 mmol/cm³, aromatics in the main chain, and quaternary ammonium groups in the side chains so that the membrane is 120 μm to 150 μm thick. A 0.5 M KHCO₃ aqueous solution is used as the electrolyte.

The solid-electrolyte electrolytic device is operated to continue the CO₂ reduction reaction for 20 hours, and the CO production current density (J_{CO}), the H₂ production current density (J_{H2}), and the CO selectivity (S_{CO}) are measured. At this time, the applied potential of the cathode is −1.8 V with respect to a silver/silver chloride reference electrode. The results are shown in Table 2. After 20 hours of continuous electrolysis, a decrease in J_{CO} and a decrease in S_{CO} are confirmed in Comparative Examples 4 and 5, while in Examples 2 and 3, the amounts of decrease in J_{CO} and S_{CO} are less than in Comparative Examples 4 and 5, confirming the effect of the technology according to the present disclosure.

TABLE 2

| | | | | | After 20 Hours of | | | | |
|---|---|---|---|---|---|---|---|---|---|
| | | Initial Stage of | | | Continuous | | | J_{CO} | S_{CO} |
| | Type of Membrane | Electrolysis | | | Electrolysis | | | 50 mA/cm² | 80% |
| | Basic Site Density [mmol/cm³] | J_{co} | J_{H2} | S_{CO} | J_{co} | J_{H2} | S_{CO} | Reached | Reached |
| Example 2 | 2.7 (Ion Exchange Resin (B)) | 76 | 1 | 99% | 61 | 2 | 97% | ✓ | ✓ |
| | 3.3 (Ion Exchange Resin (A)) | | | | | | | | |
| | 2.7 (Ion Exchange Resin (B)) | | | | | | | | |
| Example 3 | 3.3 (Ion Exchange Resin (A)) | 68 | 1 | 99% | 53 | 7 | 88% | ✓ | ✓ |
| | 2.7 (Ion Exchange Resin (B)) | | | | | | | | |
| | 3.3 (Ion Exchange Resin (A)) | | | | | | | | |
| Comparative | 3.3 | 78 | 1 | 99% | 47 | 6 | 89% | — | ✓ |
| Example 5 | | | | | | | | | |
| Comparative | 2.7 | 42 | 1 | 98% | 21 | 3 | 88% | — | ✓ |
| Example 6 | | | | | | | | | |

### REFERENCE SIGNS LIST

10, 20, 30, 40, 50, 60 Polymer ion exchange membrane
11, 21, 31, 41, 51, 61 Ion exchange resin (A)
12, 22, 32, 42, 52, 62 Ion exchange resin (B)
101 Cathode
101-1 Surface in contact with solid electrolyte of cathode
101-2 Surface in contact with current collector plate of cathode
102 Anode
102-1 Surface in contact with support plate of anode
102-2 Surface in contact with solid electrolyte of anode
103 Solid electrolyte
104 Current collector plate
104-1 Gas supply hole of current collector plate
104-2 Gas recovery hole of current collector plate
105 Support plate
105-1 Gas flow channel of support plate
106 Voltage application unit

1. A polymer ion exchange membrane, comprising:
an ion exchange resin (A); and
an ion exchange resin (B),
wherein a difference (DA—DB) between a basic site density DA of the ion exchange resin (A) and a basic site density DB of the ion exchange resin (B) is 0.3 mmol/cm³ or more.

2. The polymer ion exchange membrane according to claim 1, wherein the basic site density DA is from 0.6 mmol/cm³ to 4.0 mmol/cm³.

3. The polymer ion exchange membrane according to claim 1, wherein the basic site density DB is from 0.3 mmol/cm³ to 3.0 mmol/cm³.

4. A solid-electrolyte electrolytic device, comprising:
the polymer ion exchange membrane of claim 1.

5. A carbon dioxide electrolysis method, comprising:
using the solid-electrolyte electrolytic device of claim 4.

6. The polymer ion exchange membrane according to claim 2, wherein the basic site density DB is from 0.3 mmol/cm³ to 3.0 mmol/cm³.

7. A solid-electrolyte electrolytic device, comprising:
the polymer ion exchange membrane of claim 2.

8. A solid-electrolyte electrolytic device, comprising:
the polymer ion exchange membrane of claim 3.

9. A solid-electrolyte electrolytic device, comprising:
the polymer ion exchange membrane of claim 6.

10. A carbon dioxide electrolysis method, comprising:
using the solid-electrolyte electrolytic device of claim 7.

11. A carbon dioxide electrolysis method, comprising:
using the solid-electrolyte electrolytic device of claim 8.

12. A carbon dioxide electrolysis method, comprising:
using the solid-electrolyte electrolytic device of claim 9.
